(19) United States
(12) Patent Application Publication
(10) Pub. No.: US 2016/0283707 A1
(43) Pub. Date: Sep. 29, 2016

(54) METHOD OF UNLOCKING TOUCHSCREEN USING SEQUENTIAL GESTURES

(71) Applicant: Steve Ha, Shoreline, WA (US)

(72) Inventor: Steve Ha, Shoreline, WA (US)

(21) Appl. No.: 14/664,920

(22) Filed: Mar. 23, 2015

(51) Int. Cl. G06F 21/36; G06F 3/041; G06F 3/0484; G06F 3/0488

(52) U.S. Cl. CPC G06F 21/36; G06F 3/04883; G06F 3/0416; G06F 3/04845; G06F 2203/04808

(57) ABSTRACT

Embodiments describe methods of releasing locked touchscreen in response of valid sequential gestures previously defined by user. First method describes when touchscreen is awaken by pressing physical buttons, if it is in locked state, the touchscreen allows user to drag image to user-defined directions sequentially. If the sequential movements are corresponding to pre-defined direction and sequence, unlock of touchscreen releases. Second method, in a locked state, allows user to select divided piece on the touchscreen in sequence in order to grant a release of locked screen.

### BACKGROUND

1. Field of the Invention

This invention introduces ideas of unlocking method of touchscreen using a set of various movements and relocations of graphics. The manipulation of graphic is pre-instructed by user and memorized in electronic device which is interfaced with the touchscreen.

2. Description of the Related Art

Trend of telecommunication industry, especially the trend of features in smartphone, move very quickly by developing enhanced communication technology and adapting new demands of users as upgrading features in existing software. Every smartphone is equipped with security protection systems to secure the device from being accessed by unauthorized 3^{rd} party. Most commonly used technologies are password, pin number, and pattern which are pre-defined by authorized user. Biometric methods such as face, iris, and finger-print recognitions are being developed and began to be adapted in the recent smartphone industry although the biometric technologies currently provide low level of accuracy due to the initial stage of the technology development. Privacy may be another concern that the industry will eventually overcome to enforce the method widely adapted on the market.

Continuous development on the method of identity verification of authorized user is related with security issues as current portable communication devices can provide access to banking, social network, personal and business email. Smartphone became the one portal provides a key to essentially every important aspects of life of individual.

As important as security, convenience of user interface of the identity verification method should be addressed so that the particular method could be widely adapted and used for lengthy period to produce sufficient profit for its cost of development and investment. However in some aspects, pursuing both security and user convenience are like chasing two rabbits at the same time. Biometric method seems to meet the two requirements, but privacy is another unsettled topic the industry will carry on.

### SUMMARY

The invention is comprised of several methods of manipulation of graphics to unlock touchscreen. First method divides the touchscreen into multiple pieces where each piece is represented by distinct graphics. As an authorized user selects pieces of pre-designated graphics among multiple pieces of graphics, the user unlocks the screen and obtains access to the internal contents of the device. Second method divides the touchscreen into multiple pieces where each piece is represented by distinct graphics. As an authorized user relocates each piece into pre-designated location, the user unlocks the screen and obtains the access to the device. Another idea regarding the second method is that the graphical piece could be characters, numbers or graphical objects. As the graphical piece is aligned as pre-designated, user unlocks the screen and obtains access. Third method manipulates the screen by relocating the screen to pre-designated direction in pre-defined sequence. This particular method benefits where size of display is limited.

### BRIEF DESCRIPTION OF THE DRAWINGS

FIG. 1 illustrates that screen is divided into multiple pieces. As user selects a piece, next screen will allow user to choose another piece and repeats until all selections are completed.

FIG. 2 illustrates multiple pieces could be selected on one screen.

FIG. 3 illustrates the same procedures as FIG. 1, but circular screen is divided into pieces rather than rectangular.

FIG. 4 illustrates that multiple pieces in a circular screen could be selected.

FIG. 5 illustrates that screen is divided into multiple pieces. User relocates the pieces into pre-designated locations to unlock the screen.

FIG. 6 illustrates that a set of graphics is available for user to relocate into pre-designated locations. Screen unlocks when all graphics are aligned as pre-designated order and location.

FIG. 7 illustrates that a set of graphics is available for user to relocate into pre-designated locations. Screen unlocks when all graphics are aligned as pre-designated order and location.

FIG. 8 illustrates that user is allowed to relocate the screen to pre-designated directions in sequence. Screen unlocks as the sequential directions are corresponding to pre-defined.

FIG. 9 illustrates that multiple pieces could be relocated to pre-designated gates.

FIG. 10 illustrates that multiple pieces could be relocated to pre-designated directions.

FIG. 11 illustrates a process described in FIGS. 1, 2, 3, & 4 in a flowchart.

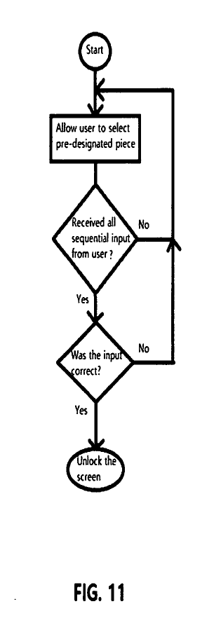

FIG. 12 illustrates a process described in FIG. 5 in a flowchart.

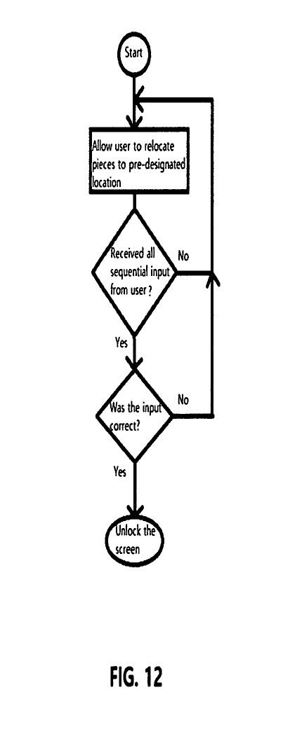

FIG. 13 illustrates a process described in FIGS. 6 & 7 in a flowchart.

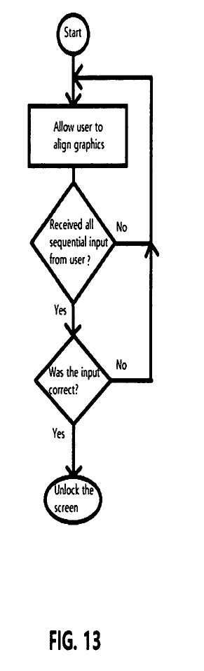

FIG. 14 illustrates a process described in FIGS. 8, 9, & 10 in a flowchart.

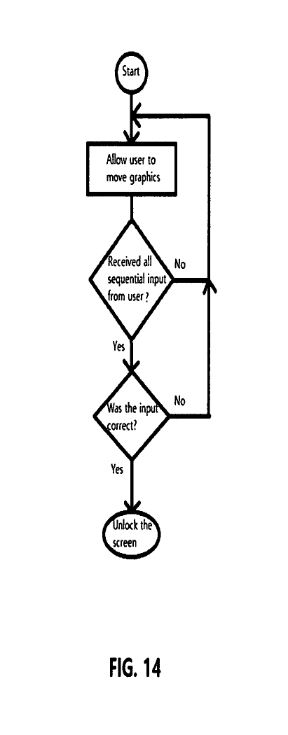

REFERENCE NUMERALS IN THE DRAWINGS

| | | | |
|---|---|---|---|
| 10 | divided piece | 12 | pre-designated piece |
| 14 | next screen | 16 | touchscreen |
| 18 | multiple pre-designated pieces | 20 | circular screen |
| 22 | multiple pieces on circular screen | 24 | pre-designated location |
| 26 | pre-designated order | 28 | align |
| 30 | pre-designated direction | 32 | undivided screen |
| 34 | gate | 36 | multiple pieces |

### DETAILED DESCRIPTION

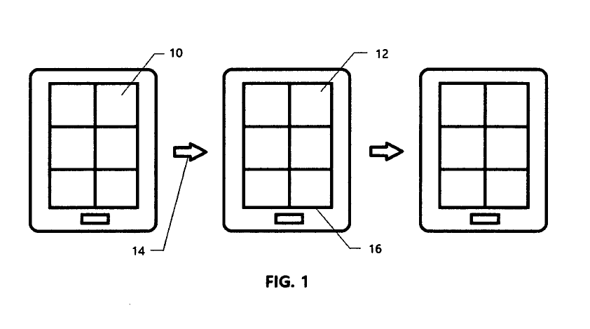

FIG. 1 illustrates that touchscreen 16 allows user to select a piece in sequence to unlock the screen. A number of sequences, a number of divided pieces 10 per screen, contents of each graphical piece, and pre-designated location of pieces could be pre-defined by user. A balance between high security and user interface convenience could be set in according to user's own preference.

To configure the unlocking system, user is allowed to set a number of sequences which allow user to identify pre-designated pieces 12. User is allowed to set a number of divided pieces 10 per screen. For example, it could be 2×2, 2×3, . . . , 10×20 or more. User is allowed to set the content of each divided piece 10 such as pictures from camera, album, or available graphics in default if provided by manufacturer. User is allowed to select one or more pre-designated pieces per each screen.

To unlock a locked screen, user will be asked to select pre-designated graphical pieces among the available pieces on the screen. Whether user selects correct pre-designated piece 12 or not, next screen 14 will appear and request to select another pieces without informing user that his/her selection is correct until the last screen is reached. If user's all selections were correct, the screen will be unlocked otherwise the screen continues to be locked and guide user to return to the initial verification stage. There may be a limitation on the number of failure for security reasons.

A pool, essentially a folder including graphics to be displayed on the screen could be set by user. User can add and delete graphics in the pool and can upload personal pictures to the pool. The pool may have multiple folders and each folder could be assigned to each screen.

User may have an option to update the location of graphics on the screen automatically. The designated piece could be associated with a particular graphics or a constant location of a piece.

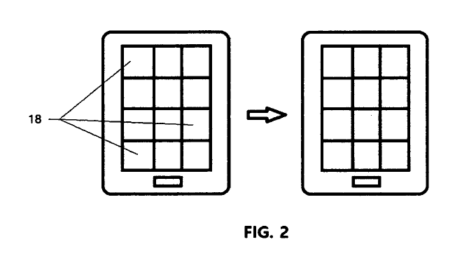

FIG. 2 illustrates multiple pre-designated pieces 18 could be selected on one screen instead of only one piece is allowed to select per screen. User is allowed to select one or more than one piece on any screens in sequence.

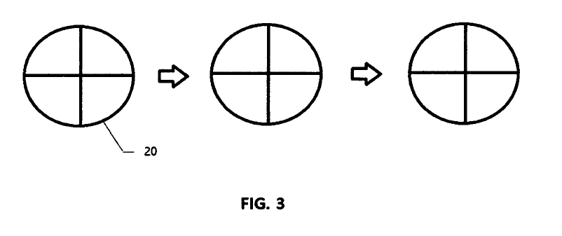

FIG. 3 illustrates that circular screen 20 is divided into pieces for the same verification procedures in FIG. 1.

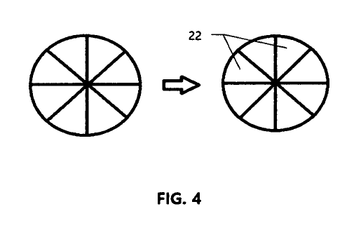

FIG. 4 illustrates that multiple pieces on circular screen 22 could be selected on one screen instead of only one piece is allowed to select per screen. User is allowed to select one or more than one piece on any screens in sequence.

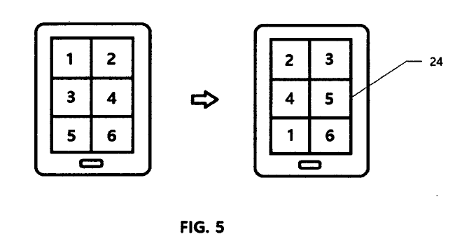

FIG. 5 illustrates that the touchscreen 16 allows user to relocate the pieces into pre-designated locations 24 to unlock the screen. A number of divided pieces 10, contents of pieces, and the final pre-designated location 24 of pieces could be pre-defined by user during initial configurations of this unlocking method. To unlock the screen, user will relocate pieces from default location to pre-designated location 24. As all the relocated pieces are located at the pre-designated location, the screen will unlock. Until all movements are completed, there will be no notification for incorrect movement for security and if the final result is not corresponding to pre-designated input, user is redirected to initial screen for retry. There can be a limitation on the number of failure for security reasons.

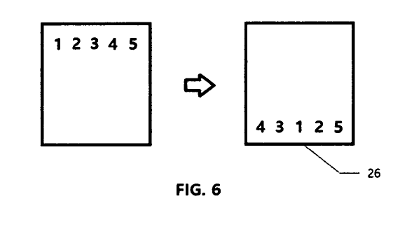

FIG. 6 illustrates that a set of graphics is available for user to relocate into pre-designated locations. Screen unlocks when all graphics are aligned as pre-designated order 26 and location. To configure the method, user is allowed to select a number of graphics to be aligned 28, contents of each graphics and pre-designated order of the graphics. Until all movements are completed, there will be no notification for incorrect movement for security and if the final result is not corresponding to pre-designated input, user is redirected to initial screen for retry. There can be a limitation on the number of failure or limitation on time per try for security reasons.

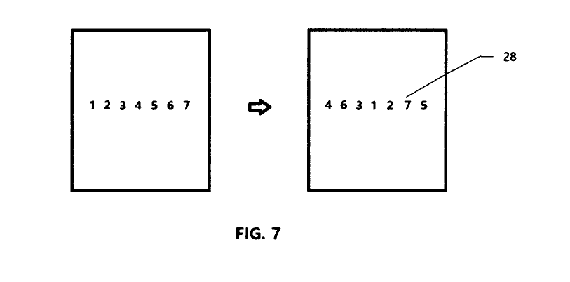

FIG. 7 illustrates that a set of graphics is available for user to relocate into pre-designated locations. Screen unlocks when all graphics are aligned as pre-designated order 26 and location. To configure the method, user is allowed to select a number of graphics to be aligned 28, contents of each graphics and pre-designated order of the graphics. Until all movements are completed, there will be no notification for incorrect movement for security and if the final result is not corresponding to pre-designated input, user is redirected to initial screen for retry. There can be a limitation on the number of failure or limitation on time per try for security reasons.

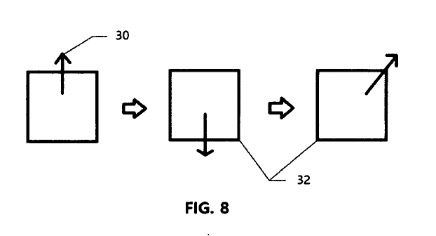

FIG. 8 illustrates that user is allowed to relocate the undivided screen 32 to various directions in sequence. To configure the unlocking method, user is allowed to select a number of screens, a pre-designated direction 30 of each screen, and graphical contents of the screens. The directional movement could be set with four directions located at 0°, 90°, 180°, 270° or eight directions located at 0°, 45°, 90°, 135°, 180°, 225°, 270°, 315° from the center of the screen. The directions could be divided even more or less as needed. Graphical contents may be selected from one of basic images provided by manufacturer or from personal album of user, or camera or other sources. Until all sequential movements are completed, there will be no notification for incorrect movement and if the sequential movements are not corresponding to pre-designated input, user is redirected to initial screen for another try. There can be a limitation on the number of failure for security reasons. Screen unlocks as the sequential directional movements are corresponding to pre-defined by user.

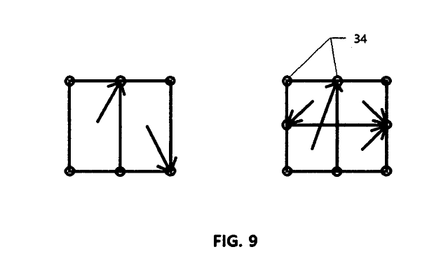

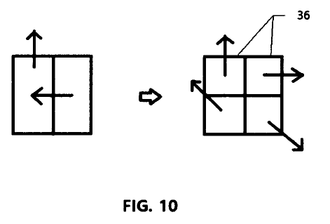

FIGS. 9 and 10 illustrate that the screen could be divided into multiple pieces and each piece is relocated into pre-designated direction 30. When there are multiple pieces 36, there could be several ways of setting directions. First is to establishing gates 34 at 0°, 45°, 90°, 135°, 180°, 225°, 270°, 315° or more or less so that pieces could be relocated to the pre-designated gates 34. Second is to assign pre-designated directions on each piece, for instance, angles at 0°, 45°, 90°, 135°, 180°, 225°, 270°, 315°.

A pool, essentially a folder, of initially available graphics could be set by user. User can add and delete graphics in the pool and can upload personal pictures to the pool. The pool may have multiple folders and each folder lists a pool of pictures and is assigned to each screen. User may have an option to change the location of graphics on the screen automatically every time.

What is claimed is:

1. Method of releasing locked state of touchscreen, comprising:
determining if touchscreen is in locked state;
displaying an image on the touchscreen; and
dragging the image to any direction on the touchscreen in sequence; and
releasing locked state of the touchscreen if sequential input is corresponding to the pre-defined sequential gesture.

2. The method of described in claim 1, where in if received sequential input is not corresponding to the pre-defined sequential gesture, the touchscreen does not release locked state and displays the image at initial position in order to provide user an additional chance of moving image in sequence to unlock the touchscreen.

3. The method of described in claim 1, where in guideline for movement is provided such as highlighted line or shaded path from original position of image to desired position of touchscreen and if the size of image is same as the entire touchscreen, guideline is omitted.

4. The method of described in claim 1, where in image or text at potential final position is displayed in order to provide visual guideline.

5. The method of described in claim 1, where in image is selected from pictures stored in the device memory.

6. The method of described in claim 1, where in one sequence is comprised of series of directional movement of image where in image is dragged and crosses final position on the touchscreen, first step of the sequence was completed, result stored in memory, and screen displays an image at initial position for next step in the same sequence; where in the process repeats until all steps in the sequence are completed and the input are received and stored in memory whether or not the result is correct.

7. The method of described in claim 1, where in numbers from 0 to 9 are displayed on the edge of touchscreen clockwise in increasing order; as dragging image from initial position to the final position where enclosed number, the associated number is entered in memory; sequentially entered numbers used as PIN number and is validated with user-defined PIN for releasing lock state of touchscreen.

8. The method of described in claim 7, where in alternatively, each number from 0 to 9 is enclosed by image, by dragging the numbered image to desired position in sequence, associated number is entered as PIN number.

9. Second method of releasing locked state of touchscreen, comprising:
determining if touchscreen is in locked state;
displaying the touchscreen divided into pieces; and
selecting a piece or pieces in sequence; and
releasing locked state of the touchscreen if the sequential selections are corresponding to the pre-defined sequential gesture.

10. The method of described in claim 8, where in if received sequential input is not corresponding to the pre-defined sequential gesture, the touchscreen does not release locked state and displays the initial touchscreen with divided pieces in order to provide user an additional chance of unlocking the touchscreen.

11. The method of described in claim 8, where in one sequence is comprised of a series of selection of piece on the touchscreen; as any selection is entered, first step of sequence is completed, result stored in memory, and screen displays an initial screen with un-selected divided pieces for next step of the same sequence; where in the process repeats until all steps in the sequence are completed and input is received and stored whether or not the result is correct; in case, if more than one piece is configured to be entered in one step, any selection of the same number of pieces configured to be entered will proceed to the next step.

12. The method of described in claim 8, where in each piece contains an image, if configured by user and the image is selected from pictures stored in device memory.

13. The method of described in claim 8, where in there is option to select more than one piece simultaneously on the screen in one step in sequence if user chooses do so.

14. The method of described in claim 8, where in touching a piece means the particular piece is selected and touching the selected piece once more removes the piece from the selection; wherein selected piece is highlighted on the touchscreen; wherein highlight turns off when removed from the selection.

15. The method of described in claim 8, where in divided pieces are divided by a line and the line is not selectable.

16. The method of described in claim 8, where in numbers from 0 to 9 are displayed on the edge of touchscreen clockwise in increasing order; wherein by selecting a piece enclosed number, the associated number is entered in memory; sequentially entered input used as PIN number and is validated with user-defined PIN for releasing lock state of touchscreen.
